(19) United States
(12) Patent Application Publication
(10) Pub. No.: US 2011/0120568 A1
(43) Pub. Date: May 26, 2011

(54) HYDRAULIC SYSTEM OF A TRANSMISSION UNIT, COMPRISING A MAIN TRANSMISSION PUMP AND AN AUXILIARY PUMP

(75) Inventors: Kai Borntraeger, Langenargen (DE); Bernard Hunold, Friedrichshafen (DE); Max Bachmann, Bad Waldsee (DE); Rene Budach, Ravensburg (DE)

(73) Assignee: ZF FRIEDRICHSHAFEN AG, Friedrichshafen (DE)

(21) Appl. No.: 13/055,290

(22) PCT Filed: Jul. 16, 2009
(86) PCT No.: PCT/EP2009/059166

§ 371 Date: Jan. 21, 2011

(30) Foreign Application Priority Data
Jul. 24, 2008 (DE) 10 2008 040 667.8

(51) Int. Cl. F15D 1/02

(52) U.S. Cl. 137/14; 137/565.01

(57) ABSTRACT

A hydraulic system of a transmission comprises a main transmission pump that can be driven by torque transmitted via the transmission unit and with an auxiliary pump that can be driven by an electric machine, by which primary and secondary pressure circuits can be supplied with hydraulic fluid. Pressure sides of the main transmission pump and the auxiliary pump are connected to the primary pressure circuit upstream of a pressure relief valve provided for adjusting a main pressure in the primary pressure circuit. The pressure relief valve is arranged between the pressure sides of the main transmission pump and the auxiliary pump and the secondary pressure circuit. The pressure side of the auxiliary pump can be actively connected with the secondary pressure circuit, via a hydraulic line which can be blocked in the direction toward the primary and secondary pressure circuits, and which bypasses the pressure-relief valve.

This application is a National Stage completion of PCT/EP2009/059166 filed Jul. 16, 2009, which claims priority from German patent application serial no. 10 2008 040 667.8 filed Jul. 24, 2008.

### FIELD OF THE INVENTION

The invention concerns a hydraulic system of a transmission unit, comprising a main transmission pump and an auxiliary pump, and a method for operating such a hydraulic system.

### BACKGROUND OF THE INVENTION

To be able to reduce both the fuel consumption and the pollutant emissions of vehicles made with internal combustion engines and known from practice, in various vehicle designs the internal combustion engine is switched off in appropriate operating states of the vehicle. Such functions are known, among other things, as engine start-stop functions and are activated or deactivated depending on the operating status of the most varied vehicle components, switching off the internal combustion engine even during short stops of the vehicle.

To ensure that conventional driving operation is not compromised by an engine start-stop function, when the driver wishes to move the vehicle on and particularly when driving onto busy streets where the vehicle has right-of-way, a quick internal combustion engine starting process and immediate force connection build-up in the transmission of the vehicle are necessary. In conventionally designed automatic transmissions, for example made with wet-operating disk clutches, the clutches are supplied with the necessary actuating pressure by a main transmission pump coupled to the transmission, but only when the internal combustion engine is running. To build up the force flow in the transmission, first of all an air gap of the clutches to be engaged must be bridged and then the clutches to be engaged must be engaged completely by raising the actuating pressure in accordance with predetermined engagement characteristics. Bridging the air gap of a clutch and engaging it in the force flow of a transmission are carried out by passing a certain hydraulic fluid volume flow into a piston space of the hydraulically controlled clutch to be engaged, this volume flow being delivered by the main transmission pump driven by the started internal combustion engine.

If, before the vehicle can start off again, a plurality of shift elements in a transmission unit are open because the internal combustion engine has been switched off and these have to be closed for the vehicle to start off again, the time interval between beginning the internal combustion engine starting process and the moment when the force flow in the transmission has been fully re-established is prolonged, sometimes to an extent which prevents a vehicle made with an engine start-stop function from being operated as effectively as desired.

Furthermore, from prior practice drive machines are known, in which the torque converter of the transmission is replaced by an electric machine so that a deficient torque increase of the engine torque during starting is compensated for by the electric machine. Such drive machines can be operated exclusively by means of the electric machine, so that when starting off under electric machine power, the speed of the electric machine, particularly when the internal combustion engine is switched off, increases from zero so that the main transmission pump cannot immediately build up the hydraulic pressure required.

To enable vehicles with transmission units designed in this way with an implemented engine start-stop function nevertheless to be operated in the desired manner, in some known vehicles besides the main transmission pump an additional, electric motor-powered auxiliary pump is provided, whose delivery volume is independent of the speed of the internal combustion engine or drive assembly.

A pressure side of the main transmission pump and a pressure side of the auxiliary pump are in this case connected to a primary pressure circuit provided in order to produce a force flow in the transmission, and in relation to the pressure sides of the pumps a pressure-relief valve is arranged downstream from the primary pressure circuit to regulate the pressure thereof, by means of which a secondary pressure circuit can be supplied with hydraulic fluid as a function of the operating situation.

The secondary pressure circuit, which is designed in particular for cooling and lubricating the assemblies of the transmission unit which can be engaged in the force flow, does not in this case have to be supplied with hydraulic fluid already at the beginning of a starting process and thus at the beginning of a force flow in the assemblies of the transmission unit, since friction work taking place for example in the clutches engaged in the force flow is only given up in the form of heat energy to the hydraulic fluid when a certain temperature difference has been established between the disks of the clutches and the hydraulic fluid. At the beginning of a starting process the heat energy produced is stored in a steel volume of the clutch disks, so no cooling is needed during that time interval.

Once a certain temperature difference has been reached between the clutch disks and the hydraulic fluid, to be able to supply both the primary and the secondary pressure circuits when the delivery volume of the main transmission pump is too small, the auxiliary pump has to provide a corresponding delivery volume and must therefore be designed with sufficient power. To produce an appropriately large auxiliary pump delivery volume, the electric machine driving the auxiliary pump must provide a power of the order of 2 kilowatts. The auxiliary pump has to be supplied with an intermediate voltage for example in the range of 350 to 620 volts, since if lower voltages are used the current size required for the electric machine to provide sufficient power would be undesirably large.

In vehicles with an Integrated Starter Generator (ISG), which in each case comprise an ISG clutch between the electric machine and the internal combustion engine, the ISG clutch must be engaged during a charging operation of an energy storage device of the electric machine then being operated as a generator. Energy storage devices based on double-layer condensers are known, which can lose their charge during servicing or after a prolonged service life, so that the voltage they provide can fall for example to less than 60 volts.

With such low voltages of the energy storage device, a desired delivery volume to be provided by the auxiliary pump for supplying the primary pressure circuit and if needs be the secondary pressure circuit cannot be achieved, so the ISG clutch cannot be engaged and automatic starting of the internal combustion engine is no longer possible. The internal combustion engine then has to be started by a 24-volt battery in order to be able to operate the electric machine as a generator to charge the double-layer condenser, but this process is only completed at the end of a time interval not acceptable to a driver.

### SUMMARY OF THE INVENTION

Accordingly, the purpose of the present invention is to provide a hydraulic system of a transmission unit with a main transmission pump and an auxiliary pump that can be driven by an electric machine, and a method for operating such a hydraulic system by means of which, compared with the solutions of the prior art, a vehicle drivetrain can be changed to a desired operating condition with a smaller and cheaper auxiliary pump within shorter operating times.

A hydraulic system of a transmission unit with a main transmission pump is proposed, which can be driven by a torque that can be delivered by the transmission unit and with an auxiliary pump that can be driven by an electric machine, by means of which a primary and secondary pressure circuit can be supplied with hydraulic fluid depending on the operating status, such that a pressure side of the main transmission pump and a pressure side of the auxiliary pump are connected to the primary pressure circuit upstream from a pressure relief valve provided for adjusting the pressure of the primary pressure circuit, and the pressure relief valve is arranged between the pressure sides of the main transmission pump and auxiliary pump and the secondary pressure circuit. According to the invention, the pressure side of the auxiliary pump can be brought into active connection with the secondary pressure circuit via a hydraulic line that bypasses the pressure relief valve and that can be blocked in the direction of the primary pressure circuit and the secondary pressure circuit.

Furthermore a method for operating such a hydraulic system is proposed, in which, if the delivery volume of the main transmission pump or a hydraulic pressure of the primary pressure circuit produced by the delivery volume of the main transmission pump is smaller than a threshold value, the hydraulic line is blocked in the direction of the secondary pressure circuit and open in the direction of the primary pressure circuit, so that the auxiliary pump supplies the primary pressure circuit with hydraulic fluid. However, if the delivery volume of the main transmission pump or a hydraulic pressure produced by the delivery volume of the main transmission pump is larger than or equal to the threshold value, the hydraulic line is opened in the direction of the secondary pressure circuit and closed in the direction of the primary pressure circuit, so that the auxiliary pump supplies the secondary pressure circuit with hydraulic fluid and the main transmission pump supplies at least the primary pressure circuit therewith.

Thanks to the use of the hydraulic system according to the invention and the operation of such a hydraulic system in accordance with the invention, compared with the conventional auxiliary pumps described at the start the auxiliary pump can advantageously be designed with lower power. This results from the fact that when the delivery volume from the main transmission pump is insufficient, the secondary pressure circuit does not have to be supplied by the auxiliary pump via the hydraulic connection through the pressure relief valve which is characterized by undesirably large hydraulic losses, but can instead be supplied with the necessary hydraulic fluid volume with a lower auxiliary pump delivery power via the hydraulic line which is characterized by a lower hydraulic resistance.

Since in the hydraulic system according to the invention, compared with auxiliary pumps known from the prior art, to fulfill the maximum demand which, when starting off, is reached with a limit increase of 30%, the auxiliary pump can be made with lower power, the auxiliary pump can be operated via a connection to a 24-volt battery, for example a 24-volt starter battery. Thus, compared with solutions known from the prior art the auxiliary pump can be made smaller and cheaper, and takes up less structural space.

Accordingly, the auxiliary pump can be supplied via the double-layer condensers mentioned earlier in any operating situation, since a reduced voltage of the double-layer condensers after a charge-loss process caused by prolonged service life or by servicing is still high enough for operating the auxiliary pump of the hydraulic system according to the invention, which is of smaller size compared with auxiliary pumps known from the prior art.

In a simply designed embodiment of the hydraulic system according to the invention, for the selective blocking or opening up of the hydraulic line that connects the auxiliary pump to the secondary circuit, the hydraulic line is provided with a change-over valve arranged between the auxiliary pump and the secondary pressure circuit which, depending on the operating situation, can be switched between a condition that opens up the hydraulic line and a condition that blocks the second hydraulic line.

The change-over valve can be switched between the condition that opens the hydraulic line and the condition that blocks it, without electric actuation means, by actuating the change-over valve as a function of a main pressure in the primary pressure circuit. In such a case it can be provided that at a main pressure, lower than or equal to a predefined threshold value, the change-over valve blocks the hydraulic line connecting the auxiliary pump to the secondary pressure circuit, whereas at a main pressure, higher than the threshold value, the hydraulic line is opened up in the area between the auxiliary pump and the secondary pressure circuit.

In a further development of the hydraulic system according to the invention which enables greater flexibility for switching the change-over valve between the hydraulic-line-blocking and the hydraulic-line-opening conditions, the change-over valve is under the pilot control of an electrically actuated magnetic valve. In this way, under appropriate pilot control by the magnetic valve, which can take place for example by virtue of a hydraulic control unit, compared with a change-over valve actuated as a function of the main pressure of the primary pressure circuit the change-over valve can be switched from the hydraulic-line-blocking to the hydraulic-line-opening switch position or vice-versa even only at pressure values higher than the threshold value.

In a further design of the hydraulic system the change-over valve can be switched between the hydraulic-line-opening and hydraulic-line-blocking conditions independently of the main pressure in the primary pressure circuit or of a pressure value equivalent thereto, by electric actuation, for example by means of the electric transmission control unit.

In a simple and inexpensive embodiment of the hydraulic system according to the invention, the connection between the pressure side of the auxiliary pump and the primary pressure circuit can be blocked by means of a one-way valve. If there is then hydraulic pressure acting on the primary pressure circuit side of the one-way valve, which is higher than the hydraulic pressure on its auxiliary pump side, the connection is automatically blocked by the one-way valve.

In a simply designed embodiment of the hydraulic system, the pressure present in the primary pressure circuit can be adjusted with little control and regulation complexity, by a pressure regulator that co-operates with the pressure relief valve.

In an advantageous variant of the method according to the invention, the hydraulic line is blocked both in the direction of the primary pressure circuit and in the direction of the secondary pressure circuit when the primary and secondary pressure circuits are both being supplied with hydraulic fluid sufficiently by the main transmission pump.

When the primary and secondary pressure circuits are both being supplied with hydraulic fluid by the main transmission pump, it is possible for the hydraulic pressure in the secondary pressure circuit to be higher than the hydraulic pressure provided by the auxiliary pump, so that no hydraulic fluid can be delivered by the auxiliary pump in the direction of the secondary pressure circuit. The auxiliary pump can then be switched off. By blocking the hydraulic line in the area between the auxiliary pump and the secondary pressure circuit, leakage of the hydraulic system in the area of the switched off auxiliary pump is avoided in a simple manner.

### BRIEF DESCRIPTION OF THE DRAWINGS

Other advantages and further developments of the invention emerge from the example embodiments whose principle is described with reference to the drawings; for the sake of clarity, the same indexes are used in the description of the example embodiments, for components having the same structure and function.

The drawings show:

FIG. 1: A very schematic representation of a hydraulic system of a transmission unit with a main transmission pump and an auxiliary pump, the auxiliary pump being connected to a secondary pressure circuit by a hydraulic line that can be blocked by a change-over valve;

FIG. 2: A representation corresponding to that of FIG. 1, showing a second example embodiment of the hydraulic system, in which the change-over valve can be switched by means of a magnetic valve; and

FIG. 3: A representation corresponding to that of FIG. 1, showing a third embodiment of the hydraulic system, in which the change-over valve can be actuated electrically.

### DETAILED DESCRIPTION OF THE PREFERRED EMBODIMENTS

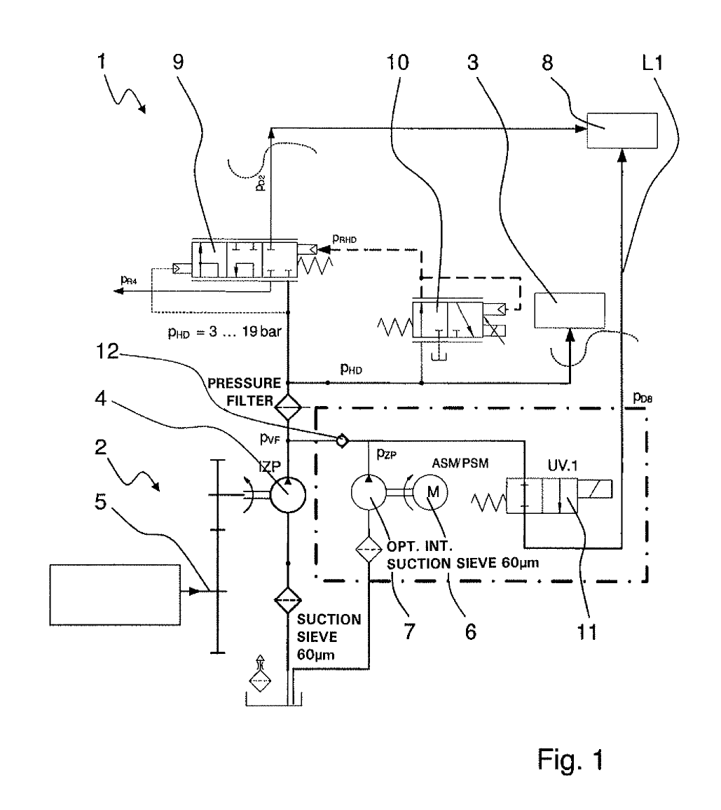

FIG. 1 shows a very schematic representation of a hydraulic system 1 of a transmission unit of a vehicle or a vehicle drivetrain, which is constructed with a hybrid drive in a manner known per se. The hybrid drive comprises a drive assembly in the form of an internal combustion engine, an electric machine 6 and a transmission unit 2. the transmission unit 2 can basically be any automated manual-shift transmission or automatic transmission known from the prior art, which is made with hydraulically actuated shift elements such as friction shifting clutches or disk brakes, and which can also be used in utility motor vehicles such as buses or the like.

In the transmission unit 2, a force flow can be produced by means of the shift elements that can be actuated hydraulically by the hydraulic system 1, the shift elements being supplied with an actuating pressure from a primary pressure circuit 3. Cooling and lubrication of the shift elements and other assemblies of the transmission unit 2 take place from a secondary pressure circuit 8 supplied with hydraulic fluid, which is subordinate in relation to the primary pressure circuit 3. A system pressure pHD or main pressure of the primary circuit is produced by a main transmission pump 4 comprising a constant pump, which can be driven mechanically by the drive assembly of the vehicle. In the present case the main transmission pump 4 is in the form of an inner gearwheel pump and can be driven via a mechanical coupling with a transmission input or a turbine shaft 5 of the transmission unit 2 by the drive assembly and, assuming a corresponding charging condition of the electrical energy storage device associated with the electric machine 6, also by the electric machine 6, although electrical operation of the main transmission pump 4 is characterized by a high demand for electrical energy.

To optimize fuel consumption and reduce pollutant emissions of the vehicle, a so-termed motor start-stop function is provided, by means of which in predefined operating conditions of the vehicle the drive assembly is switched off and is re-started, preferably by the electric machine 6, when one or more predefined starting criteria are fulfilled.

Thus for example, when the brake light is on and the vehicle is at rest and/or when the clutch pedal has been actuated by the driver, even during very short stationary phases of the vehicle when the selector lever is in position “D” for forward driving, the drive assembly is switched off, and when various start criteria are fulfilled, such as when a brake pressure falls below a threshold value, when the vehicle brake is released, when the brake light is off, when the selector lever is moved by the driver to a position where starting the drive assembly is called for, when the accelerator is actuated by more or less than a threshold value, when the control system gives notice of a drive assembly starting process, when the drive output speed is above or below a threshold value, when there is a predefined charge balance of an electric storage device of the vehicle, or as a function of comfort criteria such as a need for air-conditioning of the passenger compartment, the drive assembly is started again.

At the beginning of a process of switching on the drive assembly the turbine shaft 5 of the transmission unit 2 is driven by the drive assembly only at a low speed, so a delivery volume produced by the main transmission pump 4 is small and not sufficient to produce a hydraulic pressure in the primary pressure circuit 3 required in order to establish the force flow in the transmission unit. To be able, even in such operating conditions of a vehicle's drivetrain, to reliably provide a hydraulic pressure required for the supply of the primary circuit 3 in particular, associated with the transmission unit 2 there is in addition an auxiliary pump 7 which can be driven by the electric machine 6 and whose delivery power is independent of the speed of the turbine shaft 5, by means of which the hydraulic system pressure pHD can be produced to the desired extent in the primary circuit 3 of the hydraulic system 1 of the transmission unit 2, in particular for actuating the shift elements even when the drive assembly is switched off.

The maximum power demands are made on the auxiliary pump 7 during a starting process of a vehicle at the same time as switching on the drive assembly or internal combustion engine and with a limit increase of 30%, and in that case, for the lubrication and/or cooling of an ISG clutch that couples the electric machine 6 to the drive assembly with sufficient transmission capacity a delivery volume flow of 50 liters per minute and a hydraulic pressure of 18 bar are needed for the transmission of a combustion engine torque.

When driven purely by the electric machine, the main transmission pump 4 produces the hydraulic system pressure pHD required for supplying the primary pressure circuit at a transmission input speed above about 400 revolutions per minute, and the hydraulic fluid volume flow required for supplying the secondary pressure circuit 8 at speeds above about 1000 revolutions per minute.

A pressure side of the main transmission pump 4 and a pressure side of the auxiliary pump 7 are connected downstream to a pressure-relief valve 9, and an electrically controlled pressure regulator 10 co-operates with the pressure-relief valve 9 to adjust the system pressure pHD present in the primary pressure circuit 3. In this case the pressure-relief valve 9 is arranged between the pressure sides of the main transmission pump 4 and auxiliary pump 7 and the secondary pressure circuit 8, so that when a threshold value of the system pressure pHD that can be set by the pressure regulator 10 is reached, the pressure-relief valve 9 at least partially opens up a connection to the secondary pressure circuit 8 and the secondary pressure circuit 8 is supplied with hydraulic fluid via this hydraulic path. This ensures that a sufficient supply of the primary pressure circuit 3 with hydraulic fluid is guaranteed before the secondary pressure circuit 8 too is supplied with hydraulic fluid.

In addition, the pressure side of the auxiliary pump 7 can be brought into direct active connection with the secondary pressure circuit 8 via a hydraulic line L1, which can be blocked in the direction of the primary pressure circuit 3 and the secondary pressure circuit 8 and which bypasses the pressure-relief valve 9. In this case a change-over valve 11 arranged in the hydraulic line L1 can be switched between a position in which the pressure side of the auxiliary pump 7 is connected to the secondary pressure circuit 8, and a position in which the pressure side of the auxiliary pump 7 is cut off from the secondary pressure circuit 8.

Between the auxiliary pump 7 and the primary pressure circuit 3, the hydraulic line L1 can be blocked by a one-way valve 12, in such manner that the one-way valve 12 opens the hydraulic line L1 in the direction of the primary pressure circuit 3 when an auxiliary pump pressure in the hydraulic L1, produced by a corresponding delivery volume of the auxiliary pump 7, is higher than the hydraulic system pressure pHD on the side of the one-way valve 12 facing toward the primary pressure circuit 3. The one-way valve 12 blocks the hydraulic line L1 between the auxiliary pump 7 and the primary pressure circuit 3 when the hydraulic pressure present in the part of the hydraulic line L1 facing toward the auxiliary pump 7 is lower than the hydraulic system pressure pHD, which in relation to the one-way valve 12, is present in the area of the hydraulic line L1 facing away from the auxiliary pump 7.

If there is an operating condition of the vehicle's drivetrain in which the main transmission pump 4 is not yet providing a hydraulic system pressure pHD sufficient for supplying the primary pressure circuit 3, hydraulic fluid is delivered by the auxiliary pump 7 via the one-way valve 12 in the direction of the pressure-relief valve 9 and during this the change-over valve 11 is in its switched position that blocks the hydraulic line L1 in the direction of the secondary circuit 8. The hydraulic fluid delivery volume provided by the auxiliary pump 7 supplies the primary pressure circuit 3 with hydraulic fluid so that in this case, if the main transmission pump 4 is not delivering enough, a hydraulic system pressure pHD of 18 bar is produced in the primary circuit 3 by the auxiliary pump 7 via the pressure-relief valve 9 with a delivery volume of 10 liters per minute.

During this operating condition the secondary pressure circuit 8 is not yet, or only to a small extent supplied with hydraulic fluid via the pressure-relief valve. The friction work occurring and converted to heat energy in the shift elements of the transmission unit 2 during a starting process of the vehicle, is at first stored in the steel volume of the shift elements, so that the shift elements have not yet reached an operating temperature above which they need to be cooled and it is therefore not yet necessary to supply the secondary pressure circuit 8.

As the speed of the drive assembly and the turbine shaft 5 of the transmission unit 2 increases, so too do the delivery volume of the main transmission pump 4 and also the hydraulic pressure pHD in the primary pressure circuit 3. As a function of a pilot control pressure pRHD that can be adjusted by the pressure regulator 10 and is exerted at the pressure-relief valve 9, the system pressure pHD in the area of the pressure-relief valve 9 is set. When a pressure value of the hydraulic system pressure pHD set by means of the pressure regulator 10 is reached, hydraulic fluid is passed via the pressure-relief valve 9 in the direction of the secondary pressure circuit 8.

As the drive power of the drive assembly increases still farther, the primary pressure circuit 3 is supplied with hydraulic fluid sufficiently by the main transmission pump 4. The hydraulic system pressure pHD in the primary circuit is then increased by the pressure regulator 10 to a switching threshold of the change-over valve 11. As a result, the change-over valve 11 acted upon by the hydraulic system pressure pHD is switched to its position that connects the auxiliary pump 7 to the secondary pressure circuit 8 via the hydraulic line L1.

Due to the switching of the change-over valve 11 and the connection of the auxiliary pump 7 to the secondary pressure circuit 8, the pressure in the hydraulic line L1 falls from the level of the system pressure pHD, namely approximately 18 bar, to a pressure level preferably of 2 bar. This pressure value corresponds essentially to the counter-pressure of the hydraulic line L1 and the secondary pressure circuit 8. Since the system pressure pHD produced in the primary pressure circuit 3 by the main transmission pump 4 in relation to the auxiliary pump 7 downstream from the one-way valve 12 is then higher than the pressure in the hydraulic line L1 in relation to the auxiliary pump 7 upstream from the one-way valve 12, the hydraulic line L1 is blocked in the area of the one-way valve 12 and no hydraulic fluid is any longer delivered by the auxiliary pump 7 through the one-way valve 12 toward the primary pressure circuit 3. Since the hydraulic resistance now opposing the auxiliary pump 7 has been reduced to one-ninth, the quality delivered by the auxiliary pump 7 can theoretically be increased by a factor of 9, in order to supply shift elements to be cooled and lubricated with sufficient hydraulic fluid for this.

As the drive power of the drive assembly increases, hence also increasing the quantity delivered by the main transmission pump 4, the pressure in the primary pressure circuit 3 reaches values at which the pressure-relief valve 9 at least partially opens a connection to the secondary pressure circuit 8 so that both the secondary pressure circuit 8 and the primary pressure circuit 3 are supplied with hydraulic fluid to the desired extent. This means that an additional supply to the secondary pressure circuit 8 from the auxiliary pump through the hydraulic line L1 is no longer necessary, and the auxiliary pump 7 no longer has to be driven by the electric machine 6.

Since in its switched-off condition, when the hydraulic line L1 is open in the area of the change-over valve 11, the auxiliary pump 7 allows some leakage from the hydraulic system 1, the hydraulic system pressure pHD of the primary pressure circuit 3 exerted on the change-over valve 11 is set by the pressure regulator 10 to a pressure value lower than the switching pressure threshold of the change-over valve 11. As a result, the change-over valve 11 switches to its position that cuts the auxiliary pump 7 off from the secondary pressure circuit 8, the auxiliary pump 7 is separated from the secondary pressure circuit 8, and undesired draining away of the hydraulic fluid in the area of the auxiliary pump 7 toward an unpressurized area or oil sump of the transmission unit 2 is reliably prevented.

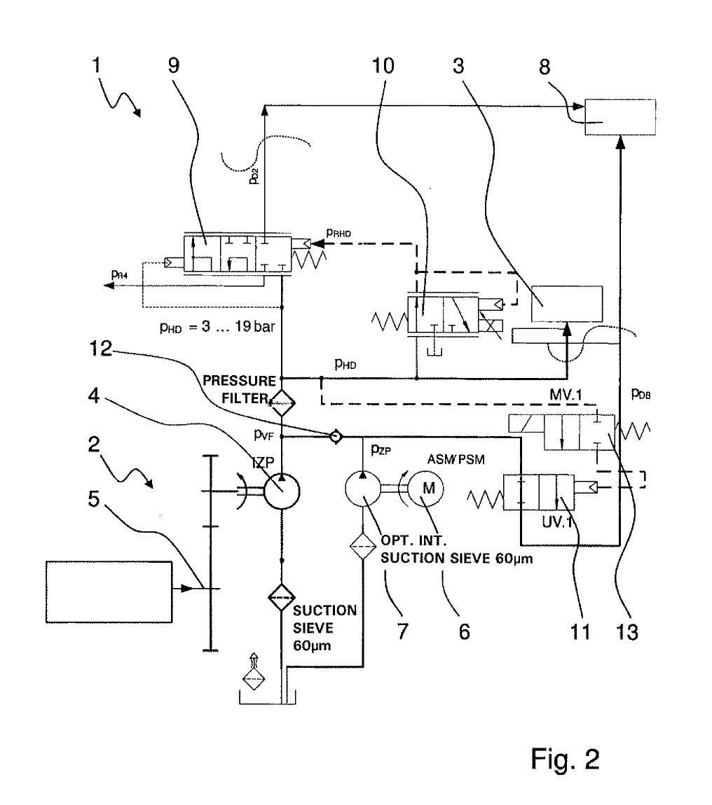

FIG. 2 shows a second example embodiment of the hydraulic system 1, which differs from the first example embodiment of the hydraulic system 1 shown in FIG. 1 essentially in the area of the change-over valve 11, so that in the description of FIG. 2 below only the differences will be explained and in relation to the other functionalities reference can be made to the description of FIG. 1.

In the hydraulic system 1 shown in FIG. 2 a magnetic valve 13 is associated with the change-over valve 11, by means of which the hydraulic system pressure pHD in the primary pressure circuit 3 can be passed on to the change-over valve 11. The magnetic valve 13, is connected upstream from the change-over valve 11, in order to be able to switch the change-over valve 11 from its position that blocks the hydraulic line L1 to the position in which it opens the hydraulic line L1, or vice-versa, as a function of the electric actuation of the magnetic valve 13 and of the system pressure pHD.

The arrangement of the magnetic valve 13 makes it possible in a simple manner to switch the change-over valve 11 from its switch position that opens the hydraulic line L1 to the switch position that blocks the hydraulic line L1 even at pressure values of the hydraulic system pressure pHD of the primary pressure circuit 3 which are higher than the switch-over pressure threshold value of the change-over valve 11, since the transmission of the system pressure pHD toward the change-over valve 11 in the area of the magnetic valve 13 can be blocked at any time by appropriate electric actuation of the magnetic valve 13.

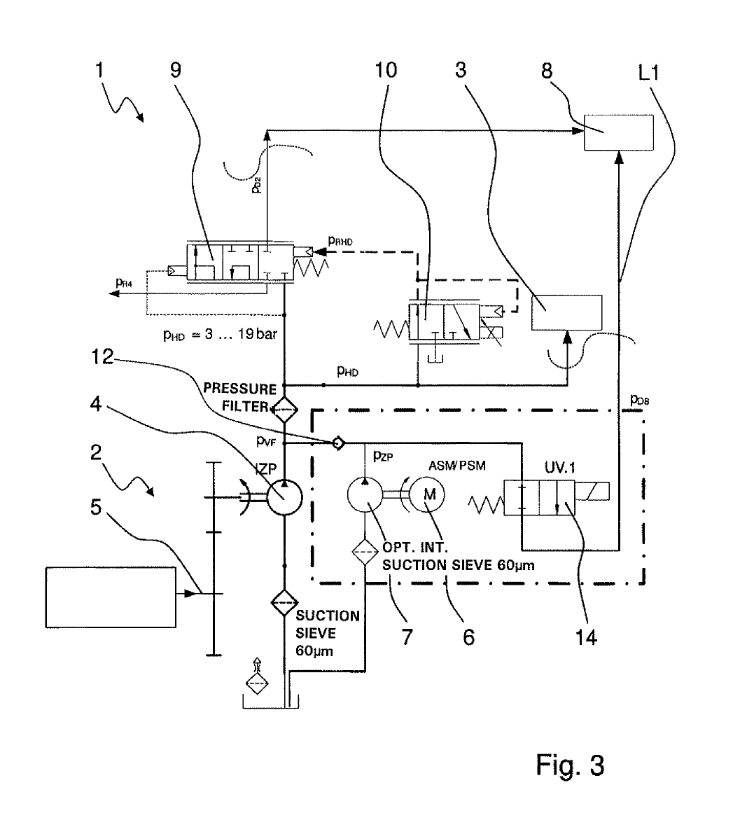

A third example embodiment of the hydraulic system 1 is shown in FIG. 3. This third example embodiment of the hydraulic system 1 differs from the example embodiments of the hydraulic system 1 shown in FIGS. 1 and 2, again only in the area of the change-over valve 11, which in the example embodiment of the hydraulic system 1 shown in FIG. 3 is designed to be switched electrically between the two switch positions described above, and thus independently of the hydraulic system pressure pHD in the primary pressure circuit 3 and also without any additional magnetic valve, in order to be able to bring the auxiliary pump 7 and the secondary pressure circuit 8 into active connection with one another when necessary.

### INDEXES

1 Hydraulic system
2 Transmission unit
3 Primary pressure circuit
4 Main transmission pump
5 Turbine shaft
6 Electric machine
7 Auxiliary pump
8 Secondary pressure circuit
9 Pressure relief valve
10 Pressure regulator
11 Change-over valve
12 One-way valve
13 Magnetic valve
L1 Hydraulic line
pHD Main pressure, hydraulic system pressure
pRHD Pilot control pressure

1-10. (canceled)

11. A hydraulic system of a transmission unit (2), the hydraulic system comprising a main transmission pump (4) being drivable by a torque that passes through the transmission unit (2), and with an auxiliary pump (7) that is drivable by an electric machine (6), by which a primary pressure circuit (3) and a secondary pressure circuit (8) are supplied with hydraulic fluid depending on an operating situation, such that a pressure side of the main transmission pump (4) and a pressure side of the auxiliary pump (7) being connected to the primary pressure circuit (3) upstream from a pressure relief valve (9) provided for adjustment of a main pressure (pHD) of the primary pressure circuit (3);
the pressure relief valve (9) being located between the pressure sides of the main transmission pump (4) and the auxiliary pump (7) and the secondary pressure circuit (8); and
the pressure side of the auxiliary pump (7) being brought into active connection with the secondary pressure circuit (8) via a hydraulic line (L1) which is blockable, in a direction of the primary pressure circuit (3) and the secondary pressure circuit (3), and which bypasses the pressure relief valve (9).

12. The hydraulic system according to claim 11, wherein the hydraulic line (L1) has a change-over valve (11) arranged between the auxiliary pump (7) and the secondary pressure circuit (8), and the change-over valve (11) is switched between a condition in which the change-over valve (11) opens the hydraulic line (L1) and a condition in which the change-over valve (11) blocks the hydraulic line (L1).

13. The hydraulic system according to claim 12, wherein, depending on the main pressure (pHD) of the primary pressure circuit (3), the change-over valve (11) is switched between a condition in which the change-over valve (11) opens the hydraulic line (L1) toward the secondary circuit (8) and a condition in which the change-over valve (11) blocks the hydraulic line (L1) in the direction toward the secondary circuit (8).

14. The hydraulic system according to claim 12, wherein the change-over valve (11) can be switched by electrical actuation between a condition in which the change-over valve (11) opens the hydraulic line (L1) toward the secondary circuit (8) and a condition in which the change-over valve (11) blocks the hydraulic line (L1) in the direction toward the secondary circuit (8).

15. The hydraulic system according to claim 12, wherein the change-over valve (11) is pilot-controlled by an electrically actuated magnetic valve (13).

16. The hydraulic system according to claim 11, wherein, when the main pressure (pHD) in the primary pressure circuit (3) is higher than a pressure acting upstream of the one-way valve (12) in relation to the auxiliary pump (7), a connection between the pressure side of the auxiliary pump (7) and the primary pressure circuit (3) is blocked in the area of a one-way valve (12).

17. The hydraulic system according to claim 11, wherein a pressure regulator (10) is associated with the pressure relief valve (9) for adjusting the main pressure (pHD) in the primary pressure circuit (3).

18. A method of operating a hydraulic system (1) comprising a main transmission pump (4) which is drivable by torque that passes through the transmission unit (2), and with an auxiliary pump (7) that is drivable by an electric machine (6), by which a primary pressure circuit (3) and a secondary pressure circuit (8) are supplied with hydraulic fluid depending on an operating situation, such that a pressure side of the main transmission pump (4) and a pressure side of the auxiliary pump (7) are connected to the primary pressure circuit (3) upstream from a pressure relief valve (9) which is provided for adjusting a main pressure (pHD) of the primary pressure circuit (3), the pressure relief valve (9) being located between the pressure sides of the main transmission pump (4) and auxiliary pump (7) and the secondary pressure circuit (8), the pressure side of the auxiliary pump (7) being brought into active connection with the secondary pressure circuit (8) via a hydraulic line (L1) which is closable in a direction of the primary pressure circuit (3) and the secondary pressure circuit (3), and which bypasses the pressure relief valve (9), the method comprising the steps of:
closing the hydraulic line (L1) in the direction toward the secondary pressure circuit (8) and opening the hydraulic line (L1) in the direction toward the primary pressure circuit (3) and supplying hydraulic fluid to the primary pressure circuit (3) with the auxiliary pump (7), when a delivery volume provided by the main transmission pump (4) is smaller than a threshold value; and
opening the hydraulic line (L1) in the direction toward the secondary pressure circuit (8) and closing the hydraulic line (L1) in the direction toward the primary pressure circuit (3), supplying hydraulic fluid to the secondary pressure circuit (8) with the auxiliary pump (7) and supplying the hydraulic fluid at least to the primary pressure circuit (3) with the main transmission pump (4), when the delivery volume provided by the main transmission pump (4) is either larger than or equal to the threshold value.

19. The method according to claim 18, further comprising the step of closing the hydraulic line (L1) both in the direction toward the primary pressure circuit (3) and in the direction toward the secondary pressure circuit (8) when the primary pressure circuit (3) and the secondary pressure circuit (8) are both supplied with hydraulic fluid by the main transmission pump (4).

20. The method according to claim 18, further comprising the step of turning off the auxiliary pump (7) when the main transmission pump (4) is supplying sufficient hydraulic fluid to both the primary pressure circuit (3) and the secondary pressure circuit (8).
